(19) United States
(12) Patent Application Publication
(10) Pub. No.: US 2021/0316172 A1
(43) Pub. Date: Oct. 14, 2021

(54) Method for virus or other pathogen protection

(71) Applicant: Benton Frederick Baugh, Houston, TX (US)

(72) Inventor: Benton Frederick Baugh, Houston, TX (US)

(21) Appl. No.: 16/847,881

(22) Filed: Apr. 14, 2020

(51) Int. Cl. A62B 23/02; B01D 45/10; A62B 9/06

(52) U.S. Cl. CPC A62B 23/025; B33Y 80/00; A62B 9/06; B01D 45/10

(57) ABSTRACT

A method of providing a virus and other pathogen protection for a person comprising providing a mask in which incoming air must pass across multiple surfaces constructed of multiple layers of a sticky material with a circuitous path to capture any airborne viruses and other pathogens irrespective of their size with the outgoing air taking a different path than the incoming air to prevent breathing moisture from interfering with the sticky capture and including a mouthpiece to prevent mask leakages.

### TECHNICAL FIELD

This invention relates to the method of preventing an airborne microscopic virus or other pathogens from entering the mouth of a wearer by passing the incoming air across numerous sticky surfaces to capture the virus or other pathogen.

### BACKGROUND OF THE INVENTION

With the spread of the coronavirus in 2020, a scramble for surgical masks was underway. Chinese officials warned of a severe mask shortage in the country. In the U.S., medical supply stores even in central Texas are experienced a mask shortage after a possible case of the virus was reported in the Brazos Valley.

But do these masks offer effective protection against the coronavirus?

It was reported in 2003, that the SARS virus, a type of coronavirus that is just 100 nanometers in size, can easily pass through such barriers as the masks which are typically used for protection. The same goes for the flu, at 80 to 120 nanometers (0.0000031496-0.0000047244 in.). While the size of the new virus is currently unknown, human coronaviruses are generally about 125 nanometers (0.0000049213 in.), so there's reason to believe this coronavirus follows suit. The original article is reprinted below.

Viruses, including the coronavirus that scientists believe may be the cause of SARS, are so tiny that they can easily pass through such barriers. Several studies even have shown that surgical masks fail to prevent transmission of the much larger Mycobacterium tuberculosis, which causes TB. While the U.S. Centers for Disease Control and Prevention advises that people who have SARS wear these masks, they do not even recommend them for people in contact with those patients unless the infected person can't wear one. Wearing surgical masks outdoors, where virus-laden particles easily disperse, has even less value.

CDC does advise health care workers working with SARS patients to wear a special mask called an N-95 respirator. But even these masks offer limited protection from coronaviruses. The name of the mask says it all. The “95” means the mask, if properly fitted- and that “fit factor” presents a big if—can filter out particles down to 0.3 microns (0.000011811 in.) 95 percent of the time. (A human hair is roughly 100 microns in diameter. (0.00393701 in.)) Human coronaviruses measure between 0.1 and 0.2 microns (0.000003937-0.000007874 in.), which is one to two times below the cutoff.

A great amount of research has been done in better filtration through smaller mechanical passages over the ages and has been intensified with the recent virus pandemic. A need is seen which does not simply search for a smaller hole is a mask to try to be smaller than the smallest virus, but rather a new approach is needed to solve this problem.

### BRIEF SUMMARY OF THE INVENTION

The object of this invention is to provide a mask which will capture any size virus or other pathogen by causing the virus or other pathogen to stick to a sticky surface.

A second object of this invention is to provide a device which will capture any virus and is not dependent on the shape of the wearer's face which tend to cause leakages around the edges of conventional masks.

A third objective of this invention is to have a mask which changes the flow path of the outgoing air to be different from the incoming air to prevent the moisture in exhaled air from interfering with the sticky surfaces.

Another objective of the invention is providing a dual stage filtering with conventional masks removing the large particles and having a sticky mask capture the smaller pathogens.

### BRIEF DESCRIPTION OF THE DRAWINGS

FIG. 1 is a side view of a man with a mask of the present invention.

FIG. 2 is a front view of a man with a mask of the present invention.

FIG. 3 is a side view of a man with a conventional cloth or paper mask being worn over the mask of the present invention.

FIG. 4, a magnified cross section of a human hair and to the same scale the smallest hole with can be made in a surgical mask and a virus.

FIG. 5 is a cross section of human hair is shown to give a relative scale for the FIGS. 5-9.

FIG. 6 is a section of a filter media which can be contained within a mask shown in a perspective view at about ten times actual scale.

FIG. 7 is a front view of section of the filter media of FIG. 6.

FIG. 8 is taken along lines “8-8” of FIG. 7 shows the offset of the of the various layers in a first direction.

FIG. 9 is taken along lines “9-9” of FIG. 7 shows the offset of the of the various layers in a second direction.

FIG. 10 is a perspective view of a mask of the present invention.

FIG. 11 is an alternate perspective view of mask of FIG. 10 taken along lines “11-11” of FIG. 10.

FIG. 12 is a top view of the FIG. 10 taken along lines “12-12”.

FIG. 13 a view of a single layer of filter media as if die cut out of a sheet of sticky material.

FIG. 14 is a perspective view of the die cut filter media of FIG. 13 showing the alternate orientations of the sheets and a stack of the sheets.

FIG. 15 is a perspective view of an alternate mask.

FIG. 16 is taken along lines “16-16” of FIG. 15.

FIG. 17 is taken along lines “17-17” of FIG. 15.

FIG. 18 is taken along lines “18-18” of FIG. 17.

### DETAILED DESCRIPTION OF THE INVENTION

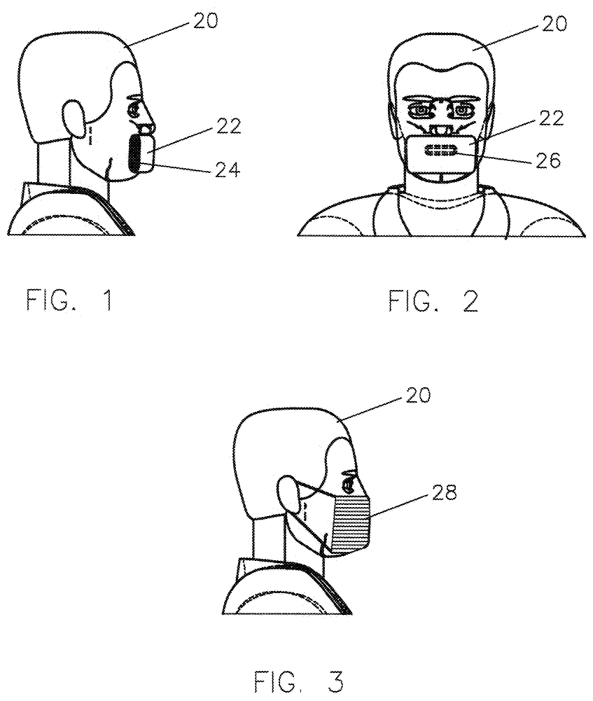

Referring now to FIG. 1, a side view of a man 20 with a mask 22 of the present invention is shown. The mask contains a special filter media 24 which will be discussed following.

Referring now to FIG. 2, a front view of a man 20 with a mask 22 of the present invention is shown. Hidden lines 26 show the mouthpiece of the mask 22.

Referring now to FIG. 3, a side view of a man 20 with a conventional cloth or paper mask 28 being worn over the mask 22 of the present invention. It is appropriate to wear the conventional paper or cloth mask over the mask of the present invention to minimize the amount of dust or other particles entering and therefore extend the life of this mask.

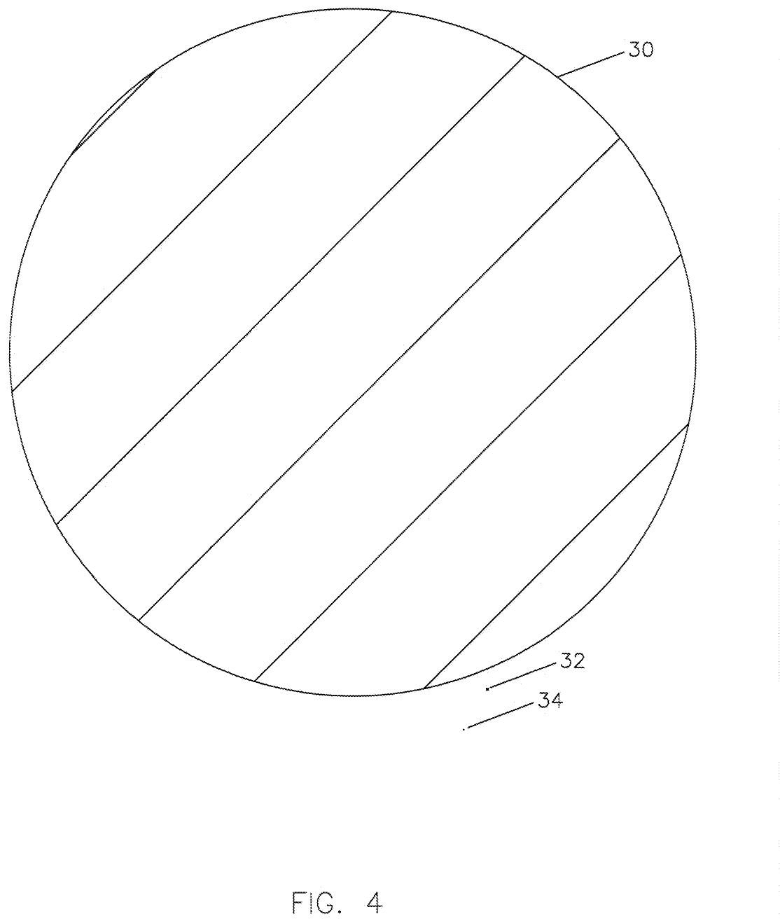

Referring now to FIG. 4, a magnified cross section 30 of a human hair is shown which is roughly 100 microns in diameter. (0.00393701 in.) and to the same scale a hole 32 is shown which is the smallest hole with can be made in a surgical mask and a coronavirus 34, which is basically a dot on the page at this scale. The hole 32 is 0.3 microns (0.000011811 in.) in diameter. The dot 34 for human coronaviruses is 0.1 microns (0.000003937 in.), which is one third the size of the hole 32. This generally means the mask with this size hole will stop coronaviruses 95% of the time, presuming the mask has a good fit with your face, which is unlikely.

Referring now to FIG. 5, a cross section of the 100 microns in diameter. (0.00393701 in.) human hair 30 is shown to give a relative scale for the FIGS. 5-9. The human hair 30 appeared to be enormous in FIG. 4, and is small in this view, but is still drawn at about ten times its actual size so effectively all FIGS. 5-9 are about ten times actual scale.

Referring now to FIG. 6, a section 40 of a filter media 24 which can be contained within mask 22 is shown in a perspective view at about ten times scale. This particular filter media is shown as printed on a 3D printer such as a UPrint SE Plus with adaptations to handling a semi-solid sticky substance. It first printed layer 42 in a first direction which are about 0.010 inches in thickness, 0.030 inches wide, and having about a 0010 gap between them. Then a second printed layer 44 is of similar size and is printed at ninety degrees to the first layer. A third layer 46 is printed at the same angle as the first layer 42, but offset in this case by 0.020 inches and then a fourth layer 48 is printed at the same angle as the second layer 44, but again offset by 0.020 inches.

The semi-solid sticky substance used to construct the filter media can be a variety of compounds which have some structural strength and remain sticky. One group of materials like this is called fugitive adhesives. Fugitive adhesives are available in the form of pressure sensitive, hot melt or water based. Also called credit card glue or booger glue, fugitive adhesives are frequently used in marketing. These low-tack adhesives produce a temporary bond between two substrates, such as paper and plastic, which releases without fiber tear. From direct mail and tipping to bookbinding and fulfillment, fugitive adhesives fit a wide variety of applications.

Fugitive glues are frequently used in marketing, where some object—product sample or a return envelope—is glued to another, usually paper, object—a mailing envelope or a magazine. They tend to perform best on smooth, non-porous surfaces. In these applications, fugitive glues are not resealable pressure-sensitive adhesives such as are used on pressure-sensitive tapes or post-it notes, although resealable formulations are available. Fugitive glues are usually available in hot melt or latex form, with low VOC emissions.

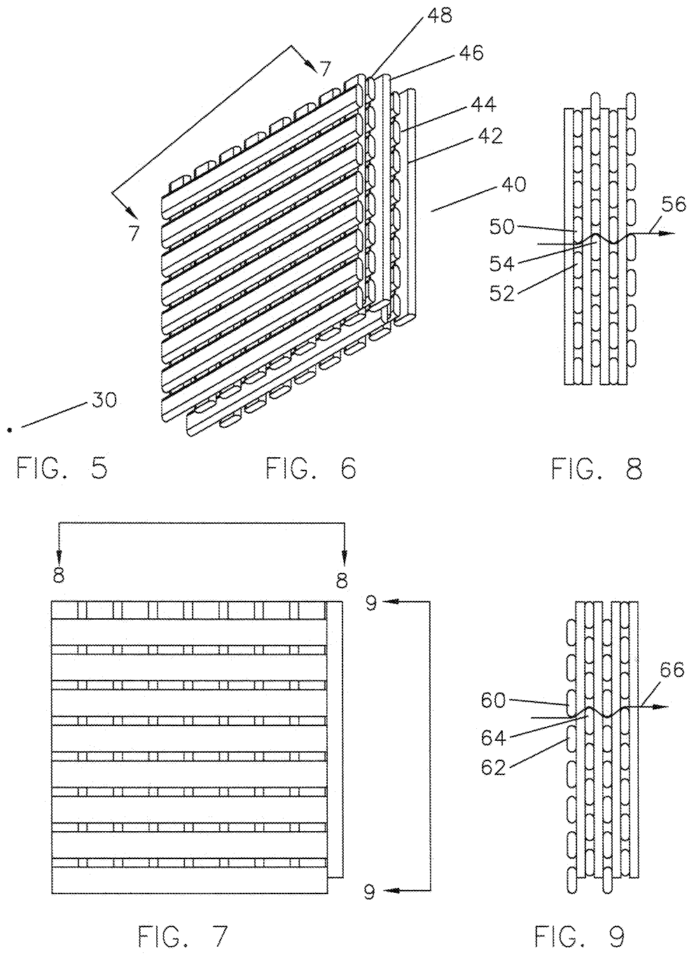

Referring now to FIG. 7, a front view of section 40 of filter media 24 is shown.

Referring now to FIG. 8, taken along lines “8-8” of FIG. 7 shows the offset of the of the various layers in a first direction indicating that although the gaps between the printed slats 50 and 52 are large in comparison to the size of the hair 30 (and therefore to the size of the virus 34) the slat 54 will block the path and cause the potential virus to be diverted back and forth generally as shown by arrow 56.

Referring now to FIG. 9, taken along lines “9-9” of FIG. 7 shows the offset of the of the various layers in a second direction indicating that although the gaps between the printed slats 60 and 62 are large in comparison to the size of the hair 30 (and therefore to the size of the virus 34) the slat 64 will block the path and cause the potential virus to be diverted back and forth generally as shown by arrow 66. The combinations of the circuitous paths as shown in FIGS. 8 and 9 mean that any breathing air containing a potential virus will be continuously mixed and the virus will be continuously be brought into contact with the sticky media material to be captured.

Referring now to FIG. 10, a perspective view of a mask 22 of the present invention is shown having a mouth piece 82 to allow perfect contact with the breathing apparatus (mouth) of the man 20, a 84 curve to fit his face, and filter media 86. Covering 88 around the filter media 86 is impermeable insuring that the air to be breathed passes fully through the filter media 86.

The shape of the filter media shown is a shape which can easily be manufactured using 3D printer technology, but other shapes can work as well. If a semi-solid or solid sticky material is formed into relatively small shapes such as spheres and simply placed into a mold, they will tend to have the same characteristics of causing passing air with potential viruses being forced to frequently change directions and expose the viruses to being captured on the sticky surfaces. The covering 88 can simply be filled with loose media, which will stick together within the covering. The loose media could be of a number shapes including small spheres and small spheres covered with sticky media.

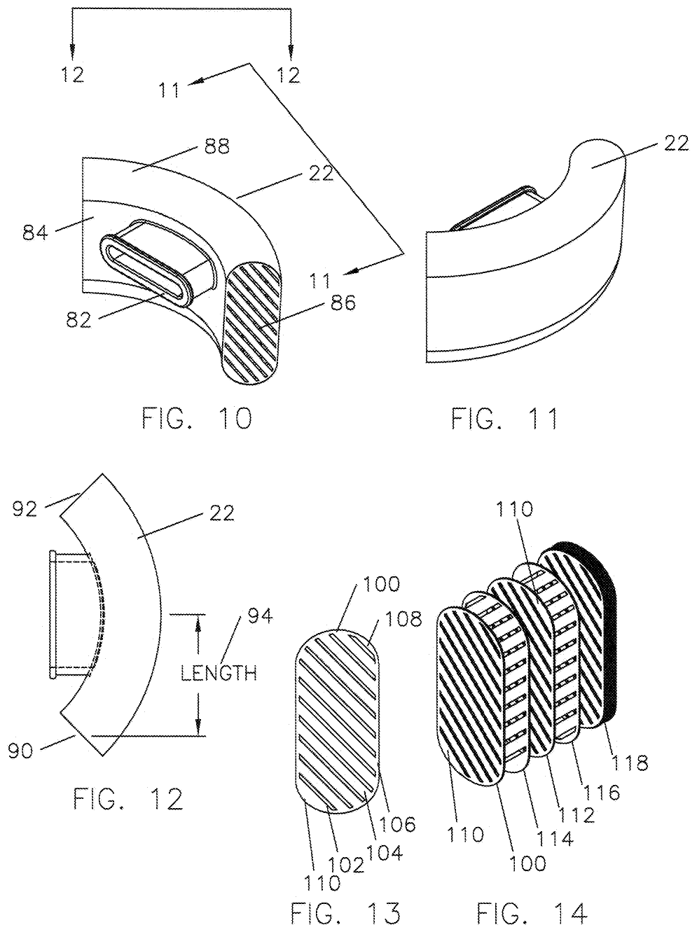

Referring now to FIG. 11, is an alternate perspective view of mask 22 taken along lines “11-11” of FIG. 10.

Referring now to FIG. 12, a top view of mask 22 is shown having inlets 90 and 92 on each end of mask 22. Length 94 is shown on the mask 22 can be approximately two inches. With the layers of the filter media being about 0.010 inches thick, this would mean that there are about two hundred layers of filter media on each side of the mask 22 or in other words two hundred turns in the air flow to being the virus into contact with the sticky media to be captured.

Referring now to FIG. 13 a view of a single layer of filter media 100 is shown as if die cut out of a sheet of sticky material. This will offer the ability to quickly cut the material into an appropriate shape in a single cut with an appropriately shaped die, probably requiring that the sticky material be made relatively cold so it will be stiff. The layer of filter media 100 will have the same narrow slots 102 likely in the range of 0.010 inches wide with a solid portion 104 again likely 0.030 inches wide. The slots 102 and solid portions 104 are shown greatly enlarged for visibility in the drawings. Additionally border 106 is shown around the filter media 100 which will seal the air flow path from leakages. A similar border would be used in the 3D printing seen in FIGS. 6-9. It will be noted that the slots are spaced differently at one end 108 than the other end 110.

Referring now to FIG. 14, die cut filter media 100 is shown as the start of what will be a stack of filter media, which are all made with the same die. The third die cut filter media 112 is simply rotated upside down so the wide area 110 is at the bottom on the first filter media and at the top on the third filter media. The second filter media 114 is turned backwards to change the angle of the slots and the fourth filter media 116 is both backwards and upside down. These four individual slices of filter media give the same pattern as was given by 42, 44, 46, and 48 in FIG. 6. This pattern is repeated three times for a total of twelve slices at 118, but as the slices are thinner than the line width of the drawing it simply appears to be a black solid.

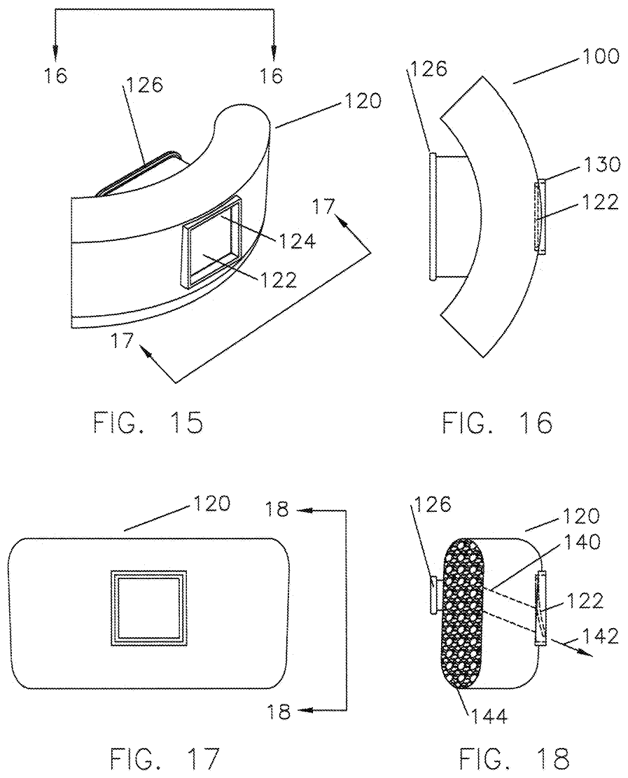

Referring now to FIG. 15, a perspective view of an alternate mask 120 is shown being similar to the mask 22 of FIGS. 10-12. The mask 22 of FIGS. 10-12 presumed that the man 20 would breath in and out through the filter media. Mask 120 provides a flap 122 which can be fixed to the mask 120 near the top at 124. Mouthpiece 126 is similar to mouthpiece 82.

Referring now to FIG. 16, taken along lines “16-16” of FIG. 15, a top view of mask 120 is shown with frame 130 projecting around the flap 122 to allow it to remain operable when a conventional cloth or paper mask such as 28 is worn over the mask 120.

Referring now to FIG. 17, a front view of mask 120 is shown taken along lines “17-17” of FIG. 15.

Referring now to FIG. 18 taken along lines “18-18” of FIG. 15 and shows passageway 140 from the mouthpiece 126 to directly behind flap 122, with flap 122 being pushed open by exhausted air as shown by arrow 142. This allows the slightly restricted flow of air through the filter to divert most of the exhausted air 142 out of the flap 122. Optionally, a similar flap or other check valve type means can be added to each external end of the filter media 86 to block any air being exhausted through the filter media and therefore forcing it all out of the flap 122. The flap 122 is an illustration of a check valve means, but other check valve means will work as well in this service. This can be beneficial to the filtering process as in some cases the moisture in the exhausted air may stick to and interfere with the stickiness of the sticky material.

Although the numerous layers of filter media will provide a large surface area for capturing the pathogens, limiting the exhaled air from passing it and a conventional cloth or paper mask restricting dust particles from clogging it will extend the life of the filter media.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

That which is claimed is:

1. A method of providing a pathogen protection for a person comprising
providing a mask in which incoming air must pass across multiple surfaces constructed of a sticky material to capture any airborne viruses and other pathogens.

2. The method of claim 1 further comprising said sticky surfaces are in layers which provide a circuitous air flow path.

3. The method of claim 2 whereas two or more individual layers comprise alternating portions with sticky material and gaps between said sticky material at a first angle spaced apart by layers comprised of alternating portions with sticky material and gaps between said sticky material at a second angle.

4. The method of claim 3 whereas said two or more individual layers comprised of alternating portions with sticky material and gaps between said sticky material at said first angle are alternately spaced such that said gaps on the first of said two or more individual layers at said first angle is blocked by the portion of sticky material in the second of said two or more individual layers at said first angle in the direction of air flow.

5. The method of claim 4 whereas said two or more individual layers comprised of alternating portions with sticky material and gaps between said sticky material at said second angle are alternately spaced such that said gaps on the first of said two or more individual layers at said second angle is blocked by the portion of sticky material in the second of said two or more individual layers at said second angle in the direction of air flow.

6. The method of claim 1 further comprising a mouthpiece.

7. The method of claim 1 further comprising said layers of stack of sticky material include a border which will adhere to the border of adjacent layers to provide a leak proof path within said sticky material.

8. The method of claim 1 further comprising providing exhaled air does not pass across said sticky surfaces on said sticky material.

9. The method of claim 1 further comprising providing said sticky material is provided in non-layered pieces.

10. A method of providing a breathing protection for a person comprising
providing a mask in which incoming air must pass across multiple surfaces constructed of a sticky material to capture any airborne viruses and other pathogens and into a mouthpiece.

11. The method of claim 10 whereas two or more individual layers comprise alternating portions with sticky material and gaps between said sticky material at a first angle spaced apart by layers comprised of alternating portions with sticky material and gaps between said sticky material at a second angle.

12. The method of claim 10 whereas said two or more individual layers comprised of alternating portions with sticky material and gaps between said sticky material at said first angle are alternately spaced such that said gaps on the first of said two or more individual layers at said first angle is blocked by the portion of sticky material in the second of said two or more individual layers at said first angle in the direction of air flow.

13. The method of claim 10 further comprising outgoing air does not pass across said sticky surfaces.

14. The method of claim 10 further comprising said layers of stack of sticky material include a border which will adhere to the border of adjacent layers to provide a leak proof path within said sticky material.

15. A method of providing a breathing protection for a person comprising
providing a mask in which incoming air must pass across multiple surfaces constructed of a sticky material to capture any airborne viruses and other pathogens and
directing breathing out air through a path which does not go across said sticky material.

16. The method of claim 15 whereas two or more individual layers comprise alternating portions with sticky material and gaps between said sticky material at a first angle spaced apart by layers comprised of alternating portions with sticky material and gaps between said sticky material at a second angle.

17. The method of claim 16 whereas said two or more individual layers comprised of alternating portions with sticky material and gaps between said sticky material at said first angle are alternately spaced such that said gaps on the first of said two or more individual layers at said first angle is blocked by the portion of sticky material in the second of said two or more individual layers at said first angle in the direction of air flow.

18. The method of claim 15 further comprising a mouthpiece.

19. The method of claim 15 further comprising said layers of stack of sticky material include a border which will adhere to the border of adjacent layers to provide a leak proof path within said sticky material.

20. The method of claim 15 further comprising providing said sticky material is provided in non-layered pieces.
